(19) United States
(12) Patent Application Publication
(10) Pub. No.: US 2007/0115628 A1
(43) Pub. Date: May 24, 2007

(54) Pushing structure for extension base

(75) Inventors: Qiu-Yue Jiang, Taipei (TW); Yung-Chi Yang, Taipei (TW); Feng Wei, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/387,201

(22) Filed: Mar. 22, 2006

(30) Foreign Application Priority Data
Nov. 24, 2005 (TW) 094220348

(51) Int. Cl. G06F 1/16

(52) U.S. Cl. 361/686

(57) ABSTRACT

A pushing structure of an extension base is disclosed. The pushing structure is used for the extension base to push a portable electronic device having a first bonding portion. The pushing structure includes a linked frame and a second bonding portion. The linked frame is jointed to the extension base and has a touching component and a propping component opposite to the touching component. The second bonding portion is jointed to the extension base and used for the linked frame to push the second bonding portion, so as to be bonded to or detached from the first bonding portion. The touching component is used to press the linked frame so as to detach the second bonding portion from the first bonding portion. The propping component is used to prop the portable electronic device so as to detach the portable electronic device from the extension base.

### BACKGROUND OF THE INVENTION

1. Field of the Invention

The present invention relates to a pushing structure of a portable electronic device and, more particularly to a pushing structure for an extension base of the portable electronic device.

2. Description of Related Arts

With great development in electronic technique, modern electronic devices become slighter, thinner, shorter and smaller for carrying conveniently. To take as an example, notebooks characterized by portability may gradually replace desktop PCs. However, as volume of the notebook is decreased, not all peripheral devices and interfaces can be disposed in the body of the notebook. For example, a modern notebook adopts a Universal Serial Bus (USB) replace parallel ports and serial ports. However, most traditional peripheral devices such as keyboard, mouse, printer, data engine, display and so on are still adopt parallel ports or serial ports. Therefore, notebooks usually need an extension base having various interfaces to connect to traditional peripheral devices.

On another hand, the extension base is convenient for a user to take a notebook outside, because the notebook may be a full-function computer while connecting to peripheral devices by using the extension base. The main character of the extension base is called Port Replicator to switch connection ports, accordingly the user needs not electrically connect to peripheral devices such as keyboard, mouse, printer or display every day. Another extension base which is called Docking Station has peripheral extensiveness such as hard disk, floppy disk, network card, compact disk and speaker except for switching connection ports, accordingly the extension base has larger volume. Thus, the extension bases can not only solve problems in plugging and pulling peripheral devices, but also satisfy expansion demands of notebooks.

Please referring to FIG. 1, which is a schematic diagram of an extension base 1 according to the prior art. The extension base 1 comprises a base 10, an electrical connector 11 fixed to the base 10 for electrically connecting a notebook (not shown in FIG.1), and a lid 12 for supporting the notebook. Generally, in order to electrically connect the extension base 1 to the notebook conveniently and effectively, guiding bodies 120 such as guiding bumps are installed in a region on the lid 20 and near the electrical connector 11. Therefore, a user can connect the notebook to the extension base 1 quickly and correctly through the use of the guiding bodies 120, and the electrical connector 11 of the extension base 1 can be electrically connected to an electrical connector of the notebook accordingly.

However, the extension base 1 is hard to be disassembled from the notebook. While demounting the extension base 1, the user has to hold the extension base 1 and the notebook to detach the two electrical connectors forcedly by using both hands, thereby it is waste of time and power to detach the extension base from the notebook; moreover, high force must be applied in disassembling operation, accordingly damages such as bend or even fracture of pins of the electrically connectors may occur.

Please refer to FIG. 2, which shows another extension base having a propping body 13, which makes the extension base easier to be disassembled from the notebook. The propping body 13 is installed on the base 10 and opposite to two sides of the electrically connector 11. When the electrical connector 11 of the extension base 1 is electrically connected to the notebook, the notebook can be propped and detached from the extension base 1 by using the propping body 13. However, the propping body 13 is distorted while the notebook is electrically connected to the extension base 1 by electrical connectors, and the electrical connectors may become loose to affect proper functions of the notebook if propping force is applied on the notebook.

To overcome the above problem caused by the propping body, another extension base having a fixing body is developed, wherein the fixing body is used to fix the extension base and the notebook firmly, yet the addition of the fixing body increases operations of mounting and demounting, thereby it is still inconvenient in use.

As a result, the present subject is to provide a pushing structure of an extension base which is convenient in mounting and demounting and has good bonding performance, such that defects in the prior art such as bad bonding performance, inconvenience in mounting and demounting, vulnerability of electrical connector and so on can be solved.

### SUMMARY OF THE INVENTION

In views of the above-mentioned problems of the prior art, it is a primary objective of the present invention to provide a pushing structure of an extension base for mounting and demounting conveniently.

It is another objective of the present invention to provide a pushing structure of an extension base having better bonding performance.

It is a further objective of the present invention to provide a pushing structure of an extension base having better controlling performance.

It is still another objective of the present invention to provide a pushing structure of an extension base for simplifying structure.

To achieve the above-mentioned and other objectives, a pushing structure of an extension base is provided according to the present invention. The pushing structure is used for the extension base to push a portable electronic device having a first bonding portion. The pushing structure includes a linked frame and a second bonding portion. The linked frame is jointed to the extension base and has a touching component and a propping component opposite to the touching component. The second bonding portion is jointed to the extension base and used for the linked frame to push the second bonding portion, so as to be bonded to or detached from the first bonding portion. The touching component is used to press the linked frame so as to detach the second bonding portion from the first bonding portion. The propping component is used to prop the portable electronic device so as to detach the portable electronic device from the extension base.

According to the preferred embodiment, the first bonding portion is a slot, and the second bonding portion is a hook. In another preferred embodiment, or both of the first and second bonding portions is a hook.

Preferably, the pushing structure further includes a first elastic component and a second component. The first elastic component is used to connect the linked frame to the extension base for providing restoring force to the touching component. The second elastic component is touched to the second bonding portion and the linked frame for providing elastic force to the second bonding portion. In one preferred embodiment, the first and second elastic components are both springs.

More preferably, the pushing structure further includes a locking component used to lock and fix the touching component. According to the preferred embodiment, the locking component has a drawbar structure.

By using the pushing structure of the present invention, the extension base can not only be bonded to the portable electronic device firmly, but also mounted and demounted to the portable electronic device easily. Accordingly, convenience and controllability in using the extension base can be increased largely.

Therefore, the pushing structure of an extension base of the present invention can provide effects such as convenience in mounting and demounting, good performance in controlling, enhancement in bonding performance and simplicity in structure, such that it solves defects in the prior art and the design flexibility of products can be increased, thereby it has high using value in industry.

### BRIEF DESCRIPTIONS OF THE DRAWINGS

FIGS. 1 and 2 are two schematic diagrams of an extension base according to the prior art;

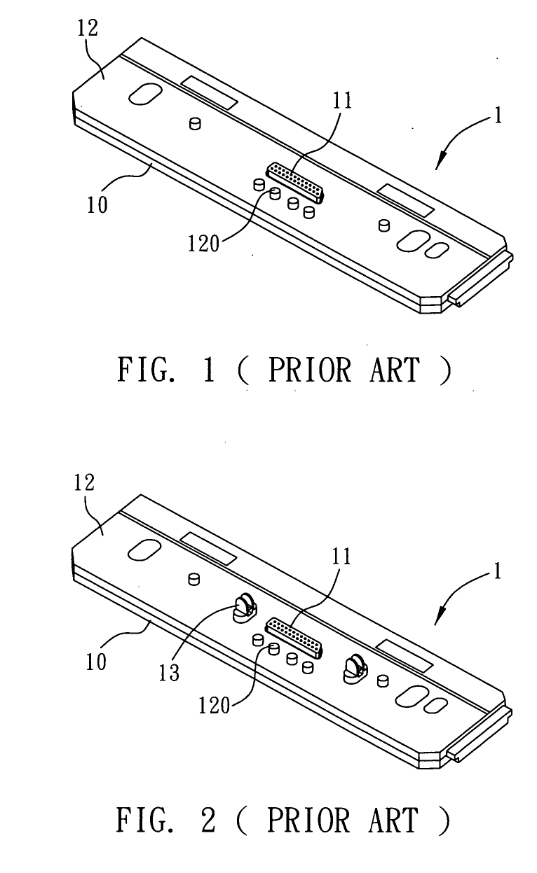

FIG. 3 is a schematic diagram of a portable electronic device and the extension base of the preferred embodiment according to the prior art;

FIG. 4 is a schematic diagram of a pushing structure of the extension base shown in FIG.3; and

FIG.5 is a schematic diagram of the pushing structure and the extension base when the pushing structure is installed in the extension base.

### DETAILED DESCRIPTIONS OF PREFERRED EMBODIMENTS

The following illustrative embodiments are provided to illustrate the disclosure of the present invention, these and other advantages and effects can be apparently understood by those in the art after reading the disclosure of this specification. The present invention can also be performed or applied by other different embodiments. The details of the specification may be on the basis of different points and applications, and numerous modifications and variations can be devised without departing from the spirit of the present invention.

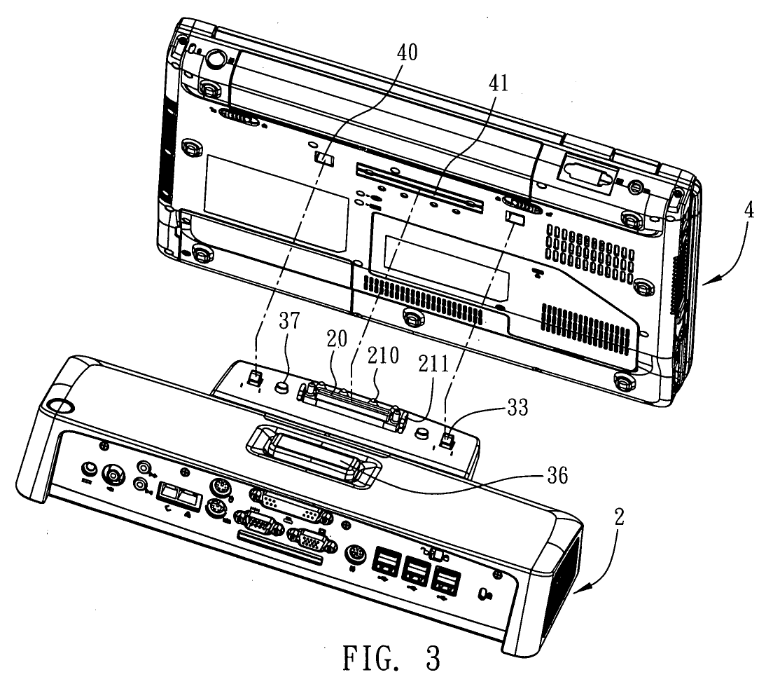

Please refer to FIG. 3, which is a schematic diagram of a portable electronic device 4 and an extension base 2 of the preferred embodiment according, to the present invention. The portable electronic device 4 comprises a first bonding portion 40. The extension base 2 comprises a pushing structure 3 and an electrical connector 20 capable of being electrically bonded to a connection port 41 of the portable electronic device 4. According to the preferred embodiment, the portable device 4 is a notebook, or a smart hand-held electronic device and so on. The extension base 2 further comprises a connection port module for connection of varieties of connection ports, such as a USB, a PS/2, a VGA, an RJ-45, an S-Video, a PCMCIA, an IEEE1394 and so on. Therefore, the extension base 2 can work with varieties of expansion equipments, such as a hard disk, a floppy disk, a network card, a compact disk, a speaker and so on. A pushing structure of the preferred embodiment is merely used to describe, but not to limit the present invention.

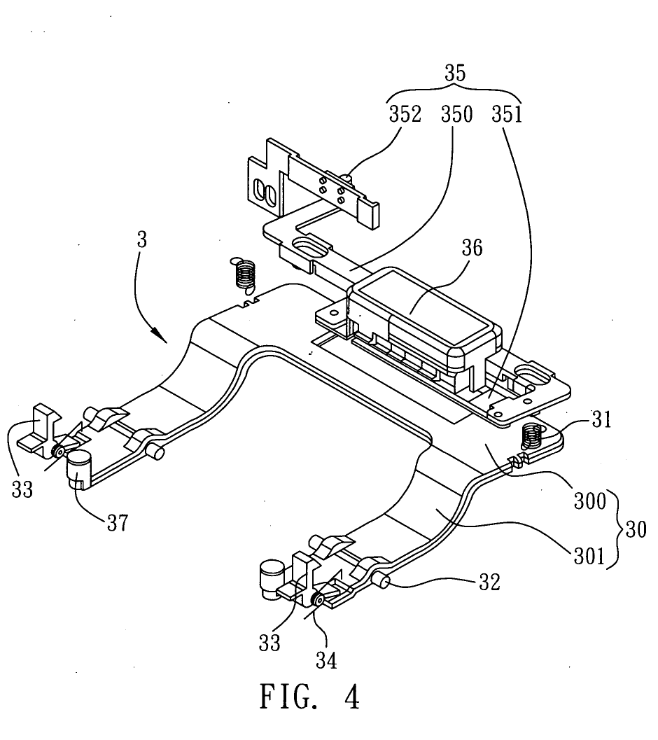

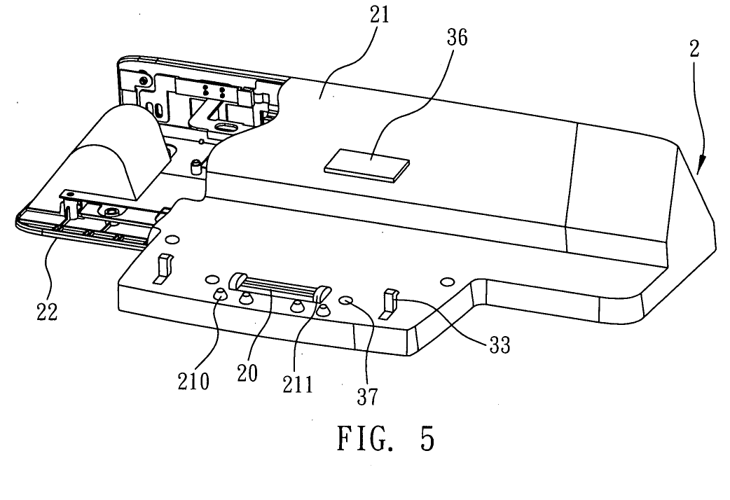

Please refer to FIGS. 4 and 5. FIG. 4 is a schematic diagram of the pushing structure 3. FIG.5 is a schematic diagram of the pushing structure 3 and the extension base 2 when the pushing structure 3 is installed in the extension base 2. The pushing structure 3 comprises a linked frame 30, two first elastic components 31, two joint components 32, two second bonding portions 33, two second elastic components 34 and a locking component 35.

The linked frame 30 is installed in the extension base 2. The linked frame 30 comprises a touching component 36 and two propping components 37 opposite to the touching component 36. The linked frame 30 comprises a cross bar 300 and two side bars 301 installed on two sides of the cross bar 300 respectively, and is in a shape of a Greek letter “Π”. The side bars 301 are jointed to the extension base 2 by the joint components 32, such that the linked frame 30 has a lever structure. The linked frame 30 is connected to the extension base 2 by the first elastic components 31 on the cross bar 300 of the linked frame 30.

According to the preferred embodiment, the first elastic component 31 is a spring or the like. The first elastic component 31 has one end connected to the side bar 301 of the linked frame 30, and the other end connected to a lid 21 of the extension base 2. The first elastic component 31 is therefore capable of providing a restoring force to restore the linked frame 30 back to an original position. The joint component 32 is used to joint the linked frame 30 to the extension base 2. According to the preferred embodiment, the joint component 32 is a plug or the like capable of jointing the linked frame 30 to a base 22 of the extension base 2.

The touching component 36 is installed on the cross bar 300 of the linked frame 30 and passes through the extension base 2 for a pressing force applied by a user to be applied on. In order that the pressing force can be evenly applied on the linked frame 30, the touching component 36 is installed in a central region of the cross bar 300. According to the preferred embodiment, the touching component 36 has a button structure.

The propping component 37 is installed on an end region of the side bar 301 of the linked frame 30 and passes through the extension base 2 for propping of the portable electronic device 4. According to the preferred embodiment, the propping component 37 can be a column, a bump or the like. The pushing structure 3 is jointed in the extension base 2. The electrical connector 20 is accommodated between the two side bars 301 and the two propping components 37 are installed in two end regions of the electrical connector 20 respectively.

The second bonding portion 33 is jointed to the extension base 2. The second bonding portion 33 can move with the movement of the linked frame 30 and be bonded with or detached from the first bonding portion 40 of the portable electronic device 4 by an elastic force provided by the second elastic component 34 such as a spring. According to the preferred embodiment, the second bonding portion 33 is jointed to the base 22 of the extension base 2, and against the end region of the side bar 301 of the linked frame 30. The second bonding portion 33 is installed approximately collinearly with the propping component 37 and the electrical connector 20. In operation, when the propping component 37 is pushed, the linked frame 30 will swing like a lever so that the end region of the side bar 301 will be applied by a great pushing force to push the second bonding portion 33, and the second bonding portion 33 will swing and be detached from the first bonding portion 40 of the portable electronic device 4. According to the preferred embodiment, the second bonding portion 33 is designed to have a structure mated with that of the first bonding portion 40, so as to fix the extension base 2 to the portable electronic device 4. The first and second bonding portions 40, 33 are preferably to be a slot and a hook respectively, but they are not limited thereto. For example, both of the first and second bonding portions 40, 33 can have hook structures capable of being coupled to each other.

The locking component 35 is installed on the touching component 36 for locking the touching component 36 on the linked frame 30. According to the preferred embodiment, the locking component 35 has a drawbar structure. The locking component 34 comprises a drawbar 350, a stopper 351 and a stirring switch 352. The stirring switch 352 passes through the lid 21 of the extension base 2. When the stirring switch 352 is pushed, the drawbar 350 is driven to move by the pushed stirring switch 352 and the stopper 351 is moved to a region under the touching component 36 and locks the touching component 36 accordingly, thereby preventing erroneous operations from occurring.

Furthermore, please refer to FIGS. 3 and 5 again. Two big-powered speakers 23 are disposed in the extension base 2 for providing more sound effects and entertainment functions to the portable electronic device 4. A guiding body 210 and an auxiliary body 211 are further installed on the lid 21. According to the preferred embodiment, the guiding body 210 can be a guiding bump or the like and is installed for positioning electrical connector 20 and the connection port 41. The auxiliary body 211 is used to touch and open a shield of the connection port 41, for the electrical connector 20 to be plugged in and electrically connected to.

In a bonding process to bond the extension base 2 to the portable electronic device 4, first the portable electronic device 4 is placed on the extension base 2, then the electrical connector 20 is accurately positioned and electrically connected to the connection port 41 by the use of the guiding body 210, and finally the second bonding portion 33 can be bonded to the first bonding portion 40 and therefore the portable electronic device 4 can be bonded to the extension base 2 firmly.

In a detaching process to detach the extension 2 from the portable electronic device 4, first the touching component 36 is pushed to drive the linked frame 30 to swing like a lever, then the swinging linked frame 30 pushes the second bonding portion 33 to shift to be detached from the first bonding portion 40 of the portable electronic device 4, and finally the touching component 37 is bounced to push the portable electronic device 4 and the electrical connector 20 is detached from the connection port 41 and the portable electronic device 4 is pushed to be detach from the extension base 2.

As a result, by using the linked frame, the second bonding portion and the propping component of the pushing structure according to the present invention, the extension base can be mounted or demounted to the portable electronic device conveniently, so controllability in using the extension base can be increased. Meanwhile, bonding performance can also be increased by firmly bonding the second bonding portion of the pushing structure of the present invention to the extension base and the portable electronic device. Furthermore, misoperation of pressing the touching component by the user can be prevented from occurrence by the appended locking component locking the touching component effectively.

The foregoing descriptions of the detailed embodiments are only illustrated to disclose the features and functions of the present invention and not restrictive of the scope of the present invention. It should be understood to those in the art that all modifications and variations according to the spirit and principle in the disclosure of the present invention should fall within the scope of the appended claims.

What is claimed is:

1. A pushing structure of an extension base, the pushing structure being used for the extension base to push a portable electronic device having a first bonding portion, the pushing structure comprising:
a linked frame jointed to the extension base, the linked frame comprising a touching component and a propping component opposite to the touching component; and
a second bonding portion jointed to the extension base and used for the linked frame to push the second bonding portion, so as to be bonded to or detached from the first bonding portion.

2. The pushing structure of claim 1, wherein the linked frame is jointed to the extension base by a joint component.

3. The pushing structure of claim 1, wherein the touching component is used to detach the second bonding portion from the first bonding portion by pressing the linked frame, and the propping component is used to detach the portable electronic device from the extension base by propping the portable electronic device.

4. The pushing structure of claim 1, wherein the extension base comprises an electrical connector, and the portable electronic device comprises a connection port corresponding to the electrical connector.

5. The pushing structure of claim 1, wherein the first bonding portion is a slot, and second bonding portion is a hook.

6. The pushing structure of claim 1, wherein the first bonding portion is a hook, and the second bonding portion is another hook.

7. The pushing structure of claim 1 further comprising a first elastic component for connecting the linked frame to a lid of the extension base.

8. The pushing structure of claim 1 further comprising a second elastic component installed between the second bonding portion and the linked frame.

9. The pushing structure of claim 7, wherein the first elastic component is a spring, and the second elastic component is another spring.

10. The pushing structure claim 1 further comprising a locking component used to lock the touching component.

11. The pushing structure of claim 10, wherein the locking component is a drawbar structure.
